(19) United States
(12) Patent Application Publication
(10) Pub. No.: US 2014/0129052 A1
(43) Pub. Date: May 8, 2014

(54) VEHICULAR BURGLAR PROOF SYSTEM AND OBSERVATION DEVICE THEREOF

(71) Applicant: YUH-SHYING GAU, Tu-Cheng (TW)

(72) Inventor: YUH-SHYING GAU, Tu-Cheng (TW)

(21) Appl. No.: 13/669,566

(22) Filed: Nov. 6, 2012

(51) Int. Cl. G06F 17/00

(52) U.S. Cl. 701/2

(57) ABSTRACT

A burglar proof system for a vehicle is provided. The burglar proof system includes a portable burglar proof device and an observation device disposed on the vehicle. The portable burglar proof device receives remote key information from a server, which includes an input unit for the user, and an operation unit produces a first value according to the remote key information and information inputted by the user. The observation device includes a validation unit and a control unit. The validation unit produces a second value according to the first value and local key information, and compares the first and second values. The control unit enables control of the engine of the vehicle when the second value is equivalent to the validation information. The disclosure further provides an observation device for the burglar proof system.

### BACKGROUND

1. Technical Field

The present disclosure relates to a burglar proof system, and particularly to a burglar proof system for a vehicle.

2. Description of Related Art

Many burglar proof systems for vehicles such as motorcycles and cars provide mechanisms such as lock assemblies. Vehicles with such systems can nevertheless be stolen relatively easily, to the great inconvenience of the user. In addition, such systems are incapable of providing any assistant in finding the vehicle after the vehicle is stolen.

What is needed, therefore, is a vehicular burglar proof system capable of overcoming the limitations described.

### BRIEF DESCRIPTION OF THE DRAWINGS

Many aspects of the present disclosure can be better understood with reference to the drawings. The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a schematic diagram of a vehicular burglar proof system of the present disclosure.

FIG. 2 is a block diagram of an embodiment of the vehicular burglar proof system shown in FIG. 1.

FIG. 3 is a schematic diagram of an embodiment of a GUI displayed on the display unit of the portable burglar proof device of the vehicular burglar proof system shown in FIG. 1.

### DETAILED DESCRIPTION

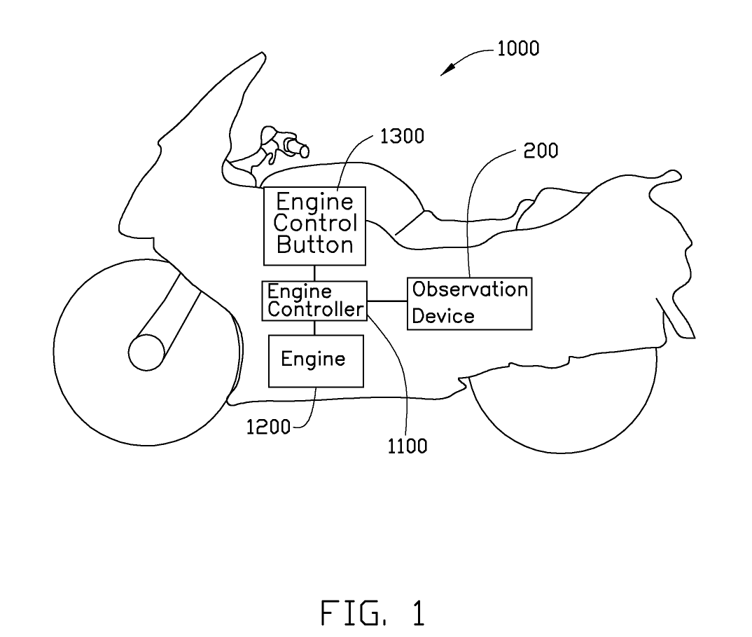

FIG. 1 is a schematic diagram of a vehicular burglar proof system of the present disclosure. The vehicular burglar proof system is applied to a vehicle 1000, for example a motorcycle or a car, and includes an engine controller 1100, an engine 1200, and an engine control button 1300. The engine controller 1100 operates the engine 1200 by, for instance, starting/stopping the engine 1200 and adjusting the speed of the engine 1200. The engine control button 1300 is coupled to the engine controller 1100, for manual starting and stopping of the engine 1200 through the engine controller 1100. In the illustrated embodiment, the engine controller 1100 is disabled from operating the engine 1200 after the engine control button 1300 has been actuated to stop the engine 1200, such that the engine control button 1300 cannot be used to start the engine 1200 thereafter.

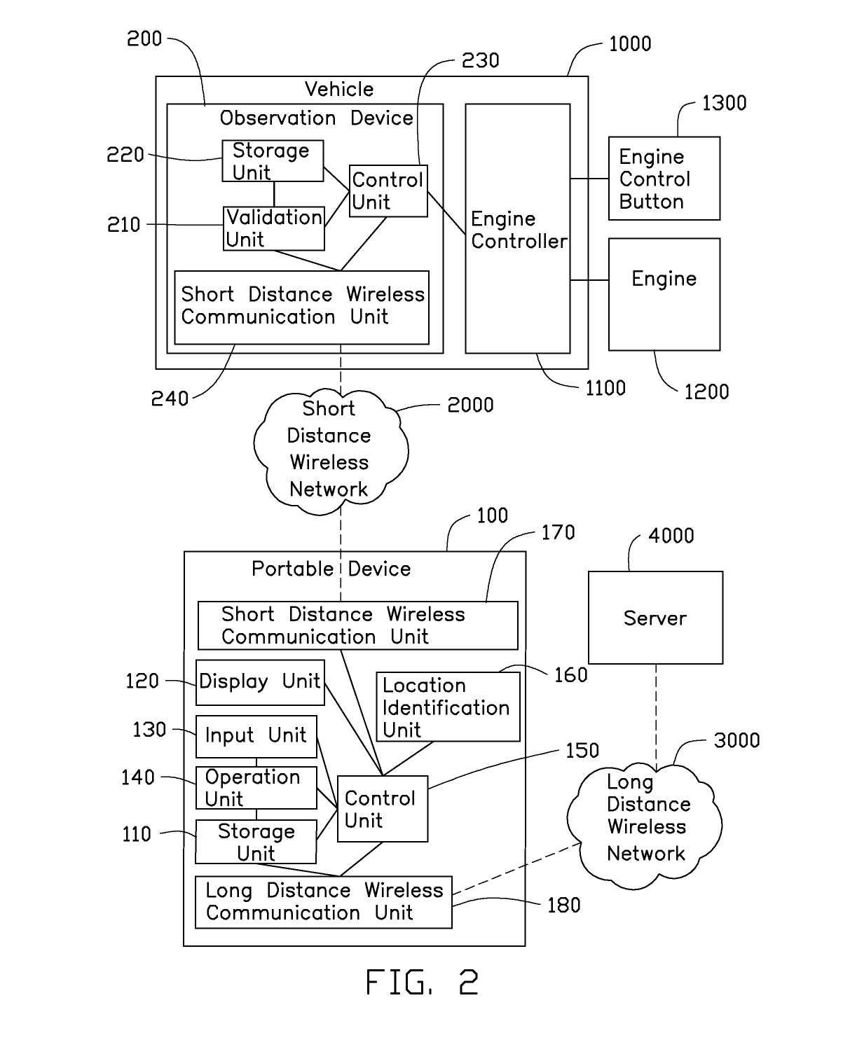

FIG. 2 is a block diagram of an embodiment of the vehicular burglar proof system shown in FIG. 1. The vehicular burglar proof system includes a portable burglar proof device 100 and an observation device 200 coupled to the engine controller 1100. The portable burglar proof device 100 communicates with the observation device 200 through a short distance wireless network 1000 implemented according to, for example, BLUETOOTH telecommunication standard, and also communicates with a server 3000 through a long distance wireless network 2000 implemented according to, for example, global system for mobile communications (GSM) or long term evolution (LTE) telecommunication standard.

The portable burglar proof device 100 includes a storage unit 110, a display unit 120, an input unit 130, an operation unit 140, a control unit 150, a location identification unit 160, a short distance wireless communication unit 170, and a long distance wireless communication unit 180. The portable burglar proof device 100 receives remote key information Ir (not shown) from the server 3000 and stores the remote key information Ir in the storage unit 110. The storage unit 110 may include a random access memory, a non-volatile memory, and/or a hard disk drive. The remote key information Ir can be a string of characters and/or numerals, for example, the word “secret”.

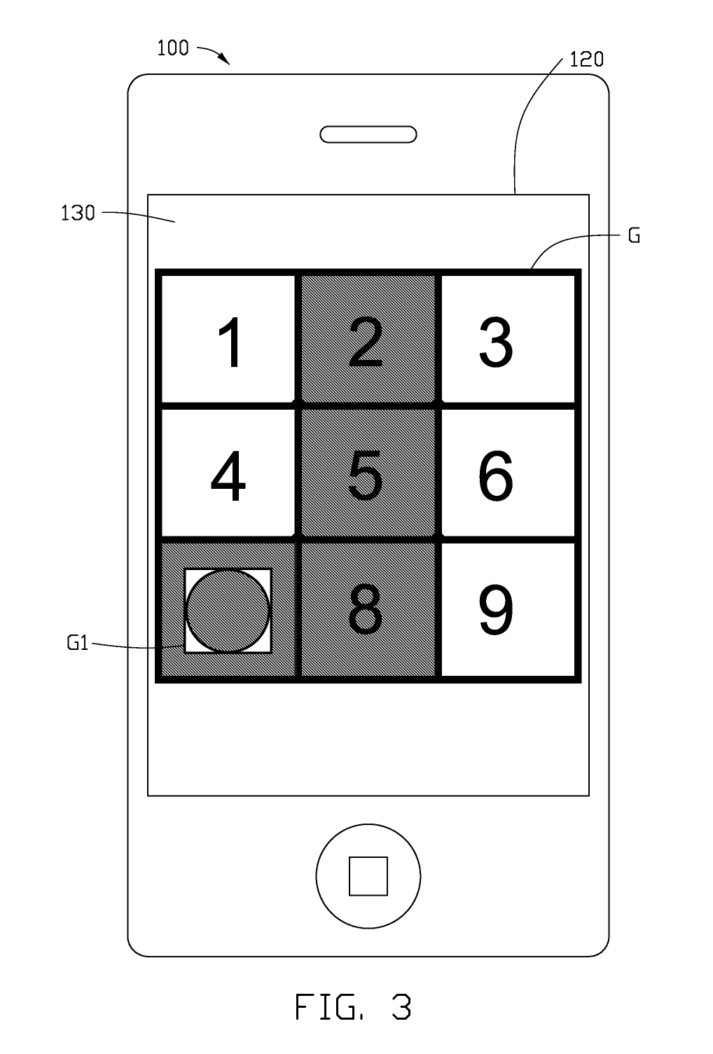

FIG. 3 is a schematic diagram of an embodiment of a graphical user interface G (GUI G) displayed on the display unit 120 of the portable burglar proof device 100 of the vehicular burglar proof system shown in FIG. 1. The display unit 120 displays the GUI G as a means whereby a user can input input information Ii (not shown), through the input unit 130, wherein the input unit 130 may include an input device such as a touch panel disposed on the display unit 120. For instance, the GUI G can be operated through an icon G1 which is a graphical, interactive user-interface object-image and which can be dragged or otherwise be moved between the grids of the GUI G, wherein each of the boxes in the grids corresponds to the input information Ii including an individual number. The input information Ii can be inputted when the icon G1 is moved into a grid of the GUI G through a sliding contact on the input unit 130.

The operation unit 140 uses a first algorithm A1 to produce a first value V1 (not shown) based on the remote key information Ir in the storage unit 110 and the input information Ii inputted by the user through the input unit 130. The first algorithm A1 may include mathematical operations such as addition, subtraction, multiplication, and division, or logical operations such as AND, OR, XOR, and NOT, on the remote key information Ir and on the input information Ii. For instance, the first algorithm A1 may convert the remote key information Ir such as the word “secret” and a string such as “2578” inputted by the user as the input information Ii into hexadecimal ASCII codes “0x 73 65 63 72 65 74” and “0x 32 35 37 38” respectively. The addition of the remote key information Ir to the input information Ii results in a total of “0x 73 65 95 A7 9C AC”, and one's complement of the total (in 8 bytes length) “0x FF FF 8C 9A 6A 58 63 53” is produced as the first value V1. In the illustrated embodiment, the first value V1 is stored in a volatile memory such as a random access memory (RAM), and the remote key information Ir in the storage unit 110 is deleted within a predetermined time period such as 24 hours after the first value V1 is produced, instead of being permanently recorded. In other embodiments, the remote key information Ir in the storage unit 110 can be deleted immediately after the first value V1 is produced.

The location identification unit 160 produces location information Ip (not shown) representing latitude, longitude, and/or elevation of the portable burglar proof device 100. In the illustrated embodiment, the location identification unit 160 is a global positioning system (GPS) receiver. The portable burglar proof device 100 communicates with the observation device 200 through the short distance wireless communication unit 170 implemented according to, for example, BLUETOOTH telecommunication standard, and communicates with the server 3000 through the long distance wireless communication unit 180 implemented according to, for example, GSM or LTE telecommunication standard. In other embodiments, the location identification unit 160 can be another type of location identification device such as WI-FI positioning system (WPS) receiver, while the location information Ip can include other types of locational data of the portable burglar proof device 100. Another type of device can be used to communicate with the observation device 200, for example, an interface implemented according to a wireless communication standard such as the GSM standard or a wire-based communication standard such as the universal serial bus (USB) standard.

The observation device 200 includes a validation unit 210, a storage unit 220, a control unit 230, and a short distance wireless communication unit 240 communicating with the portable burglar proof device 100 through the short distance wireless network 1000. The validation unit 210 uses a second algorithm A2 (not shown) to produce a second value V2 (not shown) based on the first value V1 received from the portable burglar proof device 100 and local key information Il (not shown) pre-stored in the storage unit 220, and compares the second value V2 with validation information Iv (not shown) stored in the storage unit 220. The storage unit 220 may include a random access memory, a non-volatile memory, and/or a hard disk drive, which further stores a predetermined validation value Vp (not shown) received from, for example, the portable burglar proof device 100 or from an input device of the observation device 200. The portable burglar proof device 100 can provide the predetermined validation value Vp through an application program for configuring the observation device 200.

In the illustrated embodiment, the server 3000 produces the remote key information Ir according to a first time, and the local key information Il includes a second time, wherein the first time and the second time correspond to the system time of the portable burglar proof device 100 and the system time of the observation device 200 respectively, which are generally synchronous and represent a date such as Sep. 7, 2012. Since the first time and the second time represent a same date, the remote key information Ir received from the server 3000 can be reused in the same day. In the illustrated embodiment, the validation unit 210 produces the validation information Iv according to the second time by, for instance, adding the predetermined validation value Vp to the local key information Il including the second current time.

The second algorithm A2 may convert the first time such as the digital string “20120907” into hexadecimal ASCII codes “0x 32 30 31 32 30 39 30 37”, take the sum of the first value V1 and the first time “0x 32 2F BD CC 9A 91 93 8A” as the second value V2. Since the second value V2 is produced by adding the first value V1 to the first time while the validation information Iv is produced by adding the predetermined validation value Vp to the local key information Il including the second time which is the same as the first time, the second value V2 will be equivalent to the validation information Iv when the first value V1 is equivalent to the predetermined validation value Vp. The control unit 230 enables the engine controller 1100 of the vehicle 1000 to operate the engine 1200 of the vehicle 1000 when the second value V2 is equivalent to the validation information Iv, such that the engine control button 1300 of the vehicle 1000 can be used to start and stop the engine 1200.

In the illustrated embodiment, the server 3000 can produce new remote key information Ir different from the original remote key information Ir in response to a requirement of a user when, for instance, the vehicle 1000 is stolen or lost, thereby preventing the portable burglar proof device 100 from receiving or using the remote key information Ir which is capable of enabling the engine controller 1100 of the vehicle 1000. The server 3000 may produce the new remote key information Ir including a reserved word signifying that the portable burglar proof device 100 and/or the vehicle 1000 are being used in an unauthorized way. In addition, the observation device 200 may transmit a warning message to the portable burglar proof device 100 when the second value V2 is not equivalent to the validation information Iv which may happen when, for instance, the remote key information Ir and/or the input information Ii do not correspond to the validation information Iv.

The portable burglar proof device 100 continuously transmits location messages including the location information Ip to the server 3000 in response to receiving a warning message, such that the server 3000 is constantly aware of the location of the portable burglar proof device 100 through the location information Ip. The control unit 150 may determine the presence of the reserved word in the remote key information Ir, and thereby enable the portable burglar proof device 100 to continuously transmit location messages to the server 3000 when the reserved word is found in the remote key information Ir.

The vehicular burglar proof system provides vehicle security through a portable burglar proof device communicating with a server and an observation device disposed on a vehicle. Location information of the portable burglar proof device can be continuously transmitted to the server when the portable burglar proof device is being used in an unauthorized way, so the location of the portable burglar proof device is always known.

While the disclosure has been described by way of example and in terms of preferred embodiment, the disclosure is not limited thereto. On the contrary, it is intended to cover various modifications and similar arrangements as would be apparent to those skilled in the art. Therefore the range of the appended claims should be accorded the broadest interpretation so as to encompass all such modifications and similar arrangements.

What is claimed is:

1. A burglar proof system for a vehicle, the burglar proof system comprising:
a portable burglar proof device comprising:
a wireless communication unit receiving remote key information;
an input unit inputting input information; and
an operation unit using a first algorithm to produce a first value according to the remote key information and the input information; and
an observation device disposed on the vehicle, the observation device comprising:
a validation unit using a second algorithm to produce a second value according to the first value and local key information, and comparing the second value with validation information; and
a control unit enabling an engine controller of the vehicle to operate an engine of the vehicle when the second value corresponds to the validation information.

2. The burglar proof system of claim 1, wherein the portable burglar proof device comprises a location identification unit producing location information of the portable burglar proof device.

3. The burglar proof system of claim 2, wherein the observation device transmits a warning message to the portable burglar proof device when the second value not corresponds to the validation information, the portable burglar proof device transmits one or more location messages comprising the location information to a server through the wireless communication unit in response to receiving the warning message.

4. The burglar proof system of claim 2, wherein the remote key information comprises a reserved word, the portable burglar proof device comprises a control unit determining the presence of the reserved word in the remote key information and transmits the one or more location messages comprising the location information to the server through the wireless communication unit when the reserved word is found in the remote key information.

5. The burglar proof system of claim 1, wherein the portable burglar proof device comprises a storage unit storing the remote key information, the remote key information in the storage unit is deleted in a predetermined time period after the first value is produced.

6. The burglar proof system of claim 1, wherein the portable burglar proof device comprises a storage unit storing the remote key information, the remote key information in the storage unit is deleted immediately after the first value is produced.

7. The burglar proof system of claim 1, wherein the first algorithm comprises at least one of a mathematical operation and a logical operation on the remote key information and the input information, the second algorithm comprise at least one of a mathematical operation and a logical operation on the first value and the local key information.

8. The burglar proof system of claim 1, further comprising a server producing the remote key information according to a first time, wherein the wireless communication unit of the portable burglar proof device receives the remote key information from the server.

9. The burglar proof system of claim 7, wherein the local key information comprises a second time, the validation unit of the observation device produces the validation information according to the second time.

10. An observation device disposed on a vehicle, the observation device comprising:
a communication unit receiving a first value from a portable burglar proof device with a wireless communication unit;
a validation unit using a second algorithm to produce a second value according to the first value and local key information, and comparing the second value with validation information; and
a control unit enabling an engine controller of the vehicle to operate an engine of the vehicle when the second value corresponds to the validation information.

11. The observation device of claim 10, wherein the first value is produced using a first algorithm according to remote key information and input information in the portable burglar proof device, the remote key information is received through the wireless communication unit of the portable burglar proof device.

12. The observation device of claim 10, wherein when the second value not corresponds to the validation information, the observation device transmits a warning message to the portable burglar proof device to enable the portable burglar proof device to transmit one or more location messages comprising location information of the portable burglar proof device to a server through the wireless communication unit of the portable burglar proof device in response to receiving the warning message.

13. The observation device of claim 10, wherein the second algorithm comprise at least one of a mathematical operation and a logical operation on the first value and the local key information.
